(19) United States
(12) Patent Application Publication
(10) Pub. No.: US 2010/0214286 A1
(43) Pub. Date: Aug. 26, 2010

(54) SYSTEM AND METHOD FOR COLLABORATIVE DISTRIBUTED GENERATION, CONVERSION, QUALITY AND PROCESSING OPTIMIZATION, ENHANCEMENT, CORRECTION, MASTERING, AND OTHER ADVANTAGEOUS PROCESSING OF THREE DIMENSIONAL MEDIA CONTENT

(75) Inventors: Stephen Blumenthal, Newfield, NY (US); Ilya Sorokin, New York, NY (US)

Correspondence Address: EDWARD ETKIN, ESQ., Law Office of Edward Etkin, PC, 228 West End Avenue, Suite A, Brooklyn, NY, 11235, US

(73) Assignee: 3D Fusion, Inc., New York, NY (US)

(21) Appl. No.: 12/713,126

(22) Filed: Feb. 25, 2010

Related U.S. Application Data
(60) Provisional application No. 61/155,511, filed on Feb. 25, 2009.

(51) Int. Cl. G06T 15/00

(52) U.S. Cl. 345/419

(57) ABSTRACT

The present invention is directed to a system and method for enabling multiple parties to access and utilize, separately, in parallel, and/or on a collaborative basis, a plurality of distributed modular 3D content-centric solutions that are operable to greatly improve the quality and impact of 3D media content, while decreasing the required levels of computing power, and lowering the complexity of the necessary 3D media playback and display solutions, thus maximizing the 3D experience produced therefrom. The inventive system and method facilitate and enable multiple parties to work individually or to collaborate, in a scalable and managed manner and at varying degrees, in customizable modular processes of generating, converting into, and/or beneficially processing 3D media content to produce enhanced 3D media content, and thereby greatly improving and maximizing the 3D experience produced therefrom. In various embodiments of the inventive system and method, a centralized system is provided for managing and selectively controlling access to, and utilization of, the plurality of the modular 3D content-centric solutions by a plurality of pre-registered users, and to manage 3D content-related projects by distributing individual tasks, along with appropriate access to necessary 3D content-centric solution module(s), to at least one of the plural pre-registered users. In other embodiments of the present invention, a centralized 3D content generation/conversion/processing (G/C/P) system is provided for managing 3D content-related G/C/P projects and for distributing various tasks for such projects for performance by at least one of the plural pre-registered users by enabling access thereof to necessary 3D content-centric solution module(s).

### CROSS REFERENCE TO RELATED APPLICATIONS

The present patent application claims priority from the commonly assigned co-pending U.S. provisional patent application A/N: 61/138,926 entitled “SYSTEM AND METHOD FOR COLLABORATIVE DISTRIBUTED GENERATION, CONVERSION, QUALITY AND PROCESSING OPTIMIZATION, ENHANCEMENT, CORRECTION, MASTERING, AND OTHER ADVANTAGEOUS PROCESSING OF THREE DIMENSIONAL MEDIA CONTENT”, filed Feb. 25, 2009; the present patent application also claims priority from the commonly assigned co-pending U.S. patent application A/N: 12/642,757, entitled “SYSTEM AND METHOD FOR ADAPTIVE SCALABLE DYNAMIC CONVERSION, QUALITY AND PROCESSING OPTIMIZATION, ENHANCEMENT, CORRECTION, MASTERING, AND OTHER ADVANTAGEOUS PROCESSING OF THREE DIMENSIONAL MEDIA CONTENT”, filed Dec. 18, 2009, which in turn claims priority from the commonly assigned U.S. provisional patent application A/N: 61/138,926 entitled “SYSTEM AND METHOD FOR ADAPTIVE SCALABLE DYNAMIC CONVERSION, QUALITY AND PROCESSING OPTIMIZATION, ENHANCEMENT, CORRECTION, MASTERING, AND OTHER ADVANTAGEOUS PROCESSING OF THREE DIMENSIONAL MEDIA CONTENT”, filed Dec. 18, 2008.

### FIELD OF THE INVENTION

The present invention relates generally to systems and methods for facilitating and enabling distributed (and optionally collaborative) efforts of multiple parties to generate, convert, and process enhanced 3D media content, and more particularly to systems and methods for facilitating and enabling multiple parties to collaborate, in a scalable modular and managed manner and at varying degrees, in customizable modular processes of generating, converting, and/or beneficially processing 3D media content to produce enhanced 3D media content, and thereby greatly improving and maximizing the 3D experience produced therefrom.

### BACKGROUND OF THE INVENTION

Various tools for capturing, generating, processing, playing back and displaying three dimensional (3D) content media (especially motion video), have been available for quite some time. Display technologies for 3D content media in particular have evolved quite a bit from the earliest barely passable offerings which required the audience to wear flimsy “glasses” provided with a different (red or blue) lens for each eye, to more advanced electronic “stereoscopic 3D” glasses equipped with remotely triggered liquid crystal display (LCD)-based lenses (acting as alternating individually controlled “shutters”), which provided its wearers with an engaging and quality “3D experience”, given properly prepared 3D content media paired with the appropriate playback and corresponding display technologies working on conjunction with the 3D glasses.

However, this approach for providing a “3D experience” is quite cumbersome and very expensive to use and maintain, and has thus been of very limited commercial success, primarily being relegated to special entertainment venues, such as certain IMAX theaters and high-end amusement parks. In addition to expensive, and relatively fragile, glasses being required for each member of the audience (which in some cases excludes those who cannot comfortably wear them), the latest stereoscopic 3D solutions require sophisticated and expensive computer-based components for storing and processing the 3D content, as well as similarly complex and expensive electronic components for displaying the 3D content and remotely controlling the stereoscopic 3D glasses.

Of course, as is expected, the very limited availability and expense of the above-described 3D content media playback and display technologies, in particular, have led to a relative lack of interesting 3D content (due to the expense in its creation and the very limited commercial interest therein), which in turn has resulted in a very limited availability of 3D content capture and processing tools, thus essentially resulting in a “vicious cycle”.

Nonetheless, in recent years, there has been a revolutionary leap in the solutions being offered for displaying 3D content media. Specifically, a number of companies, have developed and offered flat panel displays of varying sizes capable of creating a virtual 3D experience for the viewer without the need for the viewer to wear electronic or other types glasses or similar devices. Moreover, these displays do not require other specialized equipment and can work with specially configured 3D content that may be stored on, and played back from, conventional readily available computers. And, while these displays are still quite expensive, they are priced within reach of most organizations (and within reach of some consumers), with the price certainly poised to decrease exponentially, commensurate with an increase in production (as has been the case with the HDTV flat panel display market).

Therefore, for the past several years, ever since these newest stand-alone 3D (“SA-3D”) content media display technologies have become available at relatively reasonable prices, there has been a widespread consensus that proliferation of three-dimensional (3D) content media (both in entertainment and in advertising), as well as of the hardware and software technologies necessary for SA-3D content capture, processing, playback, and display, is inevitable, and that the market for 3D-related technologies will experience explosive growth.

Nevertheless, to date there has not been a dramatic push forward that would make the above predictions become reality. One of the main reasons for this aforementioned lack of the expected proliferation of commercially successful SA-3D-related content, software and hardware offerings, is the fact that although these newest SA-3D content media display technologies have a number of very significant advantages over all previously known 3D-related offerings, they also suffer from a number of flaws. Specifically, on the average, the quality and impact of the 3D experience delivered by the available SA-3D solutions is lower than that of conventional high-end glasses-based stereoscopic 3D offerings. Moreover the relative position of each viewer to the SA-3D screen (in terms of vertical and horizontal viewing angles, distance, etc.) has significant impact on that viewer's overall 3D experience when viewing the displayed SA-3D content. Moreover, the existing SA-3D hardware and software solutions for the capture, processing, playback and display of 3D content media have focused on areas of expertise, offer individual and discrete benefits in various narrow aspects of 3D and SA-3D technologies with little or no regard for the offerings of other solution providers, resulting in literally dozens of incompatible proprietary software and hardware products with nothing to tie them together.

In the commonly assigned co-pending U.S. patent application (A/N: 12/642,757), which is hereby incorporated herein in its entirety, entitled “SYSTEM AND METHOD FOR ADAPTIVE SCALABLE DYNAMIC CONVERSION, QUALITY AND PROCESSING OPTIMIZATION, ENHANCEMENT, CORRECTION, MASTERING, AND OTHER ADVANTAGEOUS PROCESSING OF THREE DIMENSIONAL MEDIA CONTENT”, filed Dec. 18, 2009 (hereinafter referred to as the “'757 Patent Application”), a number of very advantageous solutions to all of the above challenges, as well many other beneficial and novel, solutions, techniques, methodologies and systems, have been disclosed.

However, the effort required in conjunction with utilization of such inventive 3D content-centric solutions as have been disclosed in the above-noted applications can be quite significant in scope. Furthermore, there may be a number of content developers skilled in many aspects of working with 3D and non-3D content, but who may require access to, or who may desire to obtain the benefit of, only a portion of the results of application of the novel 3D content-centric solutions.

It would thus be desirable to provide a system and method for enabling multiple parties to work on various 3D content-related tasks on an individual, parallel, collaborative, or other basis, in utilization of a plurality of modular 3D content-centric solutions. It would also be desirable to provide a system and method that can facilitate and enable multiple parties to work on various 3D content-related tasks on an individual, parallel, collaborative, or other basis, in a scalable and managed manner, and at varying degrees, utilizing customizable modular processes of generating, converting into, and/or beneficially processing 3D media content to produce enhanced 3D media content, and thereby greatly improving and maximizing the 3D experience produced therefrom.

### BRIEF DESCRIPTION OF THE DRAWINGS

In the drawings, wherein like reference characters denote corresponding or similar elements throughout the various figures:

FIG. 1 is a schematic block diagram of an exemplary embodiment of the inventive system and infrastructure that is operable to enable distributed 3D content generation/conversion/processing, to manage and selectively control access to, and utilization of, plural modular 3D content-centric solutions by a plurality of pre-registered users, and to manage 3D content-related projects, originated by users or third party clients, for example by distributing individual tasks, along with appropriate access to necessary 3D content-centric solution module(s), to at least one of the plural pre-registered users; and

FIG. 2 is a schematic block diagram of an exemplary embodiment of a centralized 3D content generation/conversion/processing (G/C/P) system of FIG. 1.

### SUMMARY OF THE INVENTION

The present invention is directed to a system and method for enabling multiple parties to access and utilize, separately or on a collaborative basis, a plurality of distributed modular 3D content-centric solutions that are operable to greatly improve the quality and impact of 3D media content, while decreasing the required levels of computing power, and lowering the complexity of the necessary 3D media playback and display solutions, thus maximizing the 3D experience produced therefrom.

The inventive system and method facilitate, and enable, multiple parties to work on various 3D content-related tasks on an individual, parallel, collaborative, or other basis, in a scalable and managed manner, thereby optimizing the benefits available from utilization of various customizable modular processes of generating, converting into, and/or beneficially processing 3D media content to produce enhanced 3D media content, and thereby greatly improving and maximizing the 3D experience produced therefrom.

In various embodiments of the inventive system and method, a centralized system is provided for managing and selectively controlling access to, and utilization of, the plurality of the modular 3D content-centric solutions by a plurality of pre-registered users, and to manage 3D content-related projects by distributing individual tasks, along with appropriate access to necessary 3D content-centric solution module(s), to at least one of the plural pre-registered users. In other embodiments of the present invention, a centralized 3D content generation/conversion/processing (G/C/P) system is provided for managing 3D content-related G/C/P projects and for distributing various tasks for such projects for performance by at least one of the plural pre-registered users, by enabling access thereof to necessary 3D content-centric solution module(s).

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims.

### DETAILED DESCRIPTION OF PREFERRED EMBODIMENTS

The system and method of the present invention, address all of the disadvantages, flaws and drawbacks of all previously known software and/or hardware offerings for creating, converting, editing, and otherwise processing 3D-related content media, by enabling multiple parties to work individually, in parallel, and/or in a collaborative manner, in utilization of a plurality of provided novel modular scalable 3D content-centered solutions, preferably implemented in a configurable scalable and distributed infrastructure, that are operable to greatly improve the quality and impact of any 3D media content, while advantageously decreasing the required levels of computing power, and lowering the complexity of the necessary 3D media playback and 3D media display solutions, thus maximizing the 3D experience produced therefrom for one or more viewers.

Advantageously, the inventive system and method facilitate and enable multiple parties to work on various 3D content-related tasks on an individual, parallel, collaborative, or other basis, in a scalable and managed manner, and at varying degrees, thereby optimizing the benefits available from utilization of various customizable modular processes of generating, converting into, and/or beneficially processing 3D media content to produce enhanced 3D media content, and thereby greatly improving and maximizing the 3D experience produced therefrom.

In various embodiments of the inventive system and method, a centralized system is provided for managing and selectively controlling access to, and utilization of, the plurality of the modular 3D content-centric solutions by a plurality of pre-registered users, and to manage 3D content-related projects by distributing individual tasks, along with appropriate access to necessary 3D content-centric solution module(s), to at least one of the plural pre-registered users. In other embodiments of the present invention, a centralized 3D content generation/conversion/processing (G/C/P) system is provided for managing 3D content-related G/C/P projects and for distributing various tasks for such projects for performance by at least one of the plural pre-registered users by enabling access thereof to necessary 3D content-centric solution module(s). Optionally, the 3D content G/C/P system may include a collaboration system to provide additional features that may be necessary to implement and perform larger scale 3D content-related projects in a distributed and collaborative manner.

In various exemplary embodiments thereof, the inventive system and method advantageously enable automatic, semi-automatic or user-controlled selective performance of 3D content processing and/or settings/parameter configuration at one or more components of the infrastructure (from 3D content capture, to 3D content media display), and in at least one embodiment thereof, the inventive system and method are capable of determining and implementing selective or optimal storage, transmittal, and application(s) of 3D content processing/settings/parameter/profile configuration(s) prior to display of corresponding 3D content media to one or more viewers thereof.

Finally, prior to discussing the various embodiments of the present invention in greater detail below, it is important to note that while many of the embodiments of the present invention (and the various novel tools, techniques and processes relating thereto), are described and discussed as being implemented and/or utilized in the field of 3D visual entertainment (film, television, games, etc.), all embodiments of the inventive system and method, can be readily and advantageously utilized in virtually any scientific, military, medical, forensic, or industrial application based on, or involving 3D visualization or display and/or manipulation of 3D content medial, as a matter of design choice, without departing from the spirit of the invention.

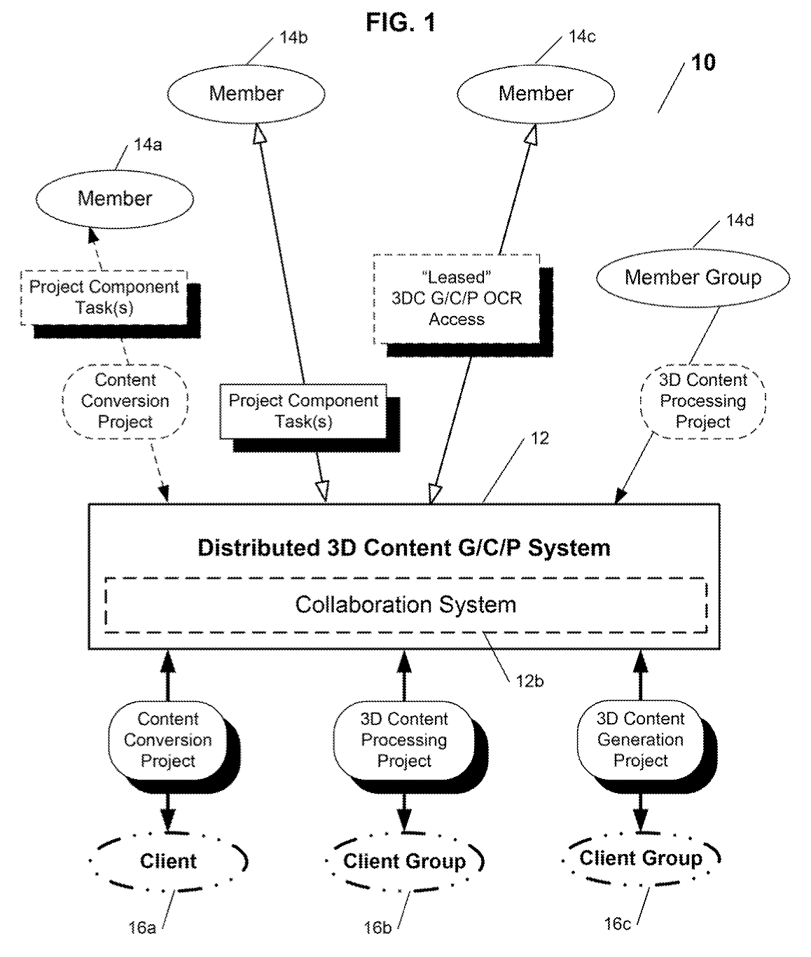

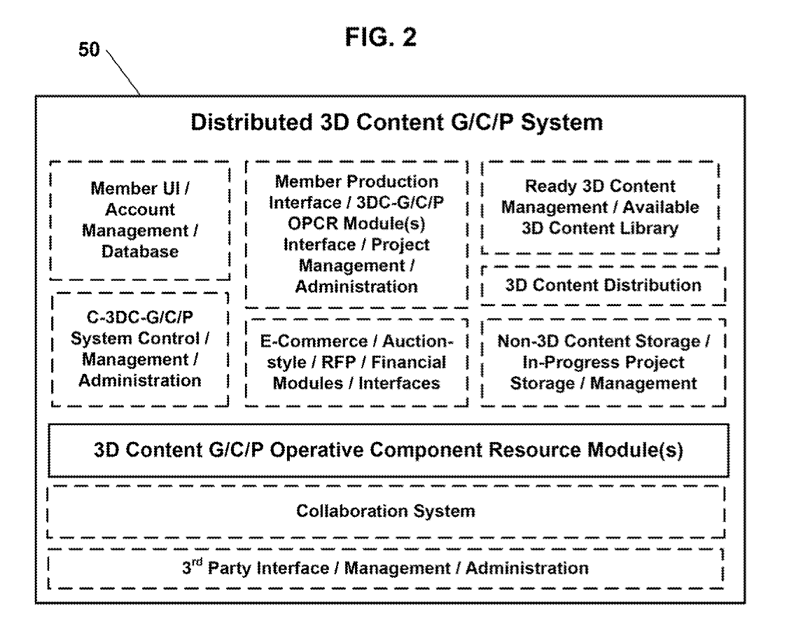

Referring now to FIG. 1, an exemplary embodiment of the inventive system and infrastructure 10, that is operable to enable distributed 3D content generation/conversion/processing, to manage and selectively control access to, and utilization of, plural modular 3D content-centric solutions by a plurality of pre-registered users, and to manage 3D content-related projects. Preferably, the inventive infrastructure 10 is organized in a “guild-like” configuration, with a distributed 3D content generation/conversion/processing (G/C/P) system 12 comprising a variety of components (shown, by way of example, in FIG. 2, and described in greater detail in connection therewith), for working with plural members 14a-14d, to enable distributed (e.g., individual, parallel, and/or collaborative) efforts on various 3D content related projects in a modular and scalable manner.

Advantageously, members may utilize the 3D content G/C/P system 12 to access predefined 3D content solutions modules and perform certain project tasks themselves, or they may receive project tasks from 3D content G/C/P system 12, or at least a portion of the project tasks may be performed by the 3D content G/C/P system 12 for the member's benefit. Optionally, the 3D content G/C/P system 12 may include a collaboration system 12b to provide additional features that may be necessary to implement and perform larger scale 3D content-related projects in a distributed and collaborative manner.

While 3D content projects may be originated by members and/or by the 3D content G/C/P system 12 owner, optionally such project requests may be received from at least one client 16a to 16c, and then managed by the 3D content G/C/P system 12, which may, by way of example, distribute one or more of the project tasks to one or more of the members 14a-14d, while granting them access to appropriate 3D content-related solutions modules/resources available to the 3D content G/C/P system 12. Optionally, certain proprietary 3D content related solutions/resources may be restricted from access by members directly, but may be utilized by the 3D content G/C/P system 12 in particular projects at the request of the member and/or client.

In another embodiment of the present invention, rather that working on a project basis, the 3D content G/C/P system 12 may offer “leased” (or otherwise task, and/or time-based) paid access by a member, to one or more of its 3D content G/C/P operative component resources.

Referring now to FIG. 2, an exemplary embodiment of an inventive centralized 3D content generation/conversion/processing (G/C/P) system 50 is shown, which may, by way of example, be the 3D content G/C/P system 12 of FIG. 1. The system 50 preferably includes a set of 3D content G/C/P operative component resource modules at least a portion of which may be accessible by the members in accordance with appropriate predefined access protocols. Various examples of preferable embodiments of these component resource modules are shown and described in the above-incorporated commonly assigned co-pending '757 Patent Application.

In summary, by way of example, the inventive system (12, 50), through selective operation of one or more modular components thereof (e.g., through one or more 3D Content G/C/P Operative Component Resource Module(s) of the system 50 (FIG. 2)), may be operable by one or more members given access thereto, to associate at least one predetermined 3D content improvement (“3DCI”) parameter set (optimization, playback, and/or display settings and/or parameters, selection of one or processing modules and/or stages of use thereof (or example during one or more of: capture, post-processing, playback or display), display tool adjustments, etc.), with 3D media content containers (for example such as have been shown and described in the above-incorporated commonly assigned co-pending '757 Patent Application).

In various embodiments of the novel 3D Content G/C/P Operative Component Resource Module(s), the optimal 3DCI parameter set comprises a plurality of “static to dynamic” display tools adjustments, which may be advantageously recorded and/or otherwise embedded in the 3D content media file, to thereby become a permanent feature thereof during later playback and/or processing (e.g., post production, etc.) of the 3D content media. In another embodiment of the present invention, the optimal 3DCI parameter set integration technique may also be utilized as a playback feature which is interpreted by a proprietary software and/or hardware 3D media player (which, by way of example can be configured as a “set top box” or equivalent), for 2D to 3D content conversion, playback of “enhanced” 3D content media having an integrated 3DCI parameter set, and for other functions (such as utilization of de-encryption solutions for playback of protected 3D content media).

Advantageously, this association and/or linking, occurs on a scalable basis from the most basic level at which an optimal 3DCI parameter set is associated with one or more corresponding 3D content media containers (that may be in a container directory, a playlist, a queue, or in a similar storage container), such that the appropriate 3DCI parameter set is activated in conjunction with its corresponding 3D content media from the container being played, to a more advanced level at which different 3DCI parameter sets are associated with (or otherwise linked or assigned to), the appropriate different portions of each 3D content media container, such that during playback and/or display thereof, different sections of the displayed content receive the optimal level of “treatment”.

By providing access to various appropriate novel 3D Content G/C/P Operative Component Resource Module(s), the inventive system and method advantageously enable authorized members to address and cover both the creation/determination/configuration of various scalable 3DCI parameter sets during 3D content capture, during initial processing, at any other time up to and including on-the-fly during playback, or any combination of the above, as a matter of design choice without departing from the spirit of the invention. Similarly, the process of creation/determination/configuration of the 3DCI parameter sets, during the utilization of various 3D Content G/C/P Operative Component Resource Module(s), can be wholly or partially automated, or can be manually performed as a “creative process” by one or more authorized members, preferably utilizing one or more 3DCI tools and support modules made available thereto through the accessed 3D Content G/C/P Operative Component Resource Module(s), as desired, or as necessary. By way of example, such resource modules may also include the “Blue Box” system offered by Phillips, or equivalent solutions from other 3D content—related software/hardware solutions providers. Other advantageous system 50 components and elements relating to member/client/project/content administration and management, as well as to other advantageous functions, solutions, and tasks are also shown in FIG. 2.

When the above-described combined technology package (hereinafter referred to as a “3DF-3DVC system”), is used with conventional and/or novel 3D display tool adjustments and settings, (which, in accordance with the present invention may be readily embedded into a 3D content media file (and optionally recorded/captured “on-the-fly”)) as the desired 3D content related project outcome, the resulting output not only corrects any remaining 3D video image issues/flaws, but, at the same time, provides the basis for wide-scale distributed development and essentially “viral” implementation of various guidelines and tools for rapidly effecting a major increase in the impact of the depth perspective visuals in the display of various available and future 3D content media, thus establishing the methodology and infrastructure that is required for widespread production and proliferation of 3D stereoscopic video broadcast quality standards, and for implementation, administration, and management thereof.

For example, various inventive 3DF-3DVC system techniques may be employed in all of 3DVC server applications, through various 3D Content G/C/P Operative Component Resource Module(s), to effectively upgrade the 3D content media quality through “Re-mastering”. When these techniques are applied to pre-converted 2D+Depth, “.s3D” 3D video clips, which are designed for display on conventional commercially available 3D ASD screens, advantageously, the issues of depth error correction, cone double image removal and ghosting artifacts may be corrected and therefore eliminated.

The novel techniques and solutions provided in various embodiments of the inventive system and method, and referenced above in connection with their advantageous ability to synergistically combine with, and vastly improve, conventional 3D systems and solutions (e.g., 3DVC servers, etc.) are shown and described in greater detail in the above-incorporated commonly assigned co-pending '757 Patent Application).

Thus, while there have been shown and described and pointed out fundamental novel features of the inventive system and method as applied to preferred embodiments thereof, it will be understood that various omissions and substitutions and changes in the form and details of the devices and methods illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. It is the intention, therefore, to be limited only as indicated by the scope of the claims appended hereto.

We claim:

1. A distributed system for improving the efficiency, quality, and/or impact of a 3D experience capable of being provided to at least one viewer of 3D content media, comprising:
at least one system component operable to enable automatic, semi-automatic or user-controlled selective performance of 3D content processing and/or settings/parameter configuration functions on at least one predetermined 3D content media element,
wherein at least one of said at least one system component is further operable to determine and implement selective or optimal storage, transmittal, and application(s) of 3D content processing/settings/parameter/profile configuration(s), prior to, or during display of corresponding 3D content media to one or more viewers thereof; and
at least one means for selectively enabling at least one predefined user of a plurality of pre-registered users to access and utilize at least one of said at least one system components in accordance with at least one predetermined component access protocol.
